(19) United States
(12) Patent Application Publication
(10) Pub. No.: US 2003/0030875 A1
(43) Pub. Date: Feb. 13, 2003

(54) Method for channel tagging in DWDM optical communication systems

(76) Inventor: Tomasz Barczyk, Ottawa (CA)

Correspondence Address: HARNESS, DICKEY & PIERCE, P.L.C., P.O. BOX 828, BLOOMFIELD HILLS, MI, 48303, US

(21) Appl. No.: 09/925,058

(22) Filed: Aug. 8, 2001

(51) Int. Cl. H04J 14/02; H04B 10/04

(52) U.S. Cl. 359/182; 359/124

(57) ABSTRACT

An improved method is provided for channel tagging optical data signals in an optical communication system. The method includes: generating an optical carrier having a given wavelength from an optical signal source; modulating the frequency of the optical carrier at the optical signal source, thereby embedding a tag in the optical carrier; modulating the tagged optical carrier with a data signal to form an optical data signal; and transmitting the optical data signal in the optical communication system. The method may further comprise detecting the embedded signal tag using an FM demodulator.

### FIELD OF THE INVENTION

The present invention relates generally to dense wavelength division multiplexing (DWDM) optical communication systems and, more particularly, to a method for channel tagging in DWDM optical communication systems.

### BACKGROUND OF THE INVENTION

Dense wavelength division multiplexing (DWDM) technology offers an attractive, cost-effective way for the telecommunication industry to expand optical network bandwidth. This technology allows the industry to meet the ever growing requirements for new telecommunication services. However, as more and more optical data signals are passing through more and more complex optical networks, there is also a growing need for a low cost method to manage optical network traffic.

Channel tagging is one known approach used to manage optical network traffic. A unique tag may be added to each channel carried by an optical data signal. The channel tags are transmitted at a relatively slow rate using low depth amplitude modulation and then used to manage optical network traffic in a DWDM optical communication system. In this approach, a low speed, low cost detector may be used to detect the channel tags embedded in an optical data signal. An exemplary method of such channel tagging is described in U.S. Pat. No. 6,108,113.

However, since it requires that all tags form a set of orthogonal codes, this approach is relatively slow in the context of DWDM optical systems. Moreover, channel tags formed using amplitude modulation have a number of other limitations in the context of long haul optical networks. In particular, such channel tags directly contribute to the overall optical penalty associated with a given channel and, at low modulation rates, do not propagate well through the long chains of optical amplifiers commonly employed in long haul optical networks.

Therefore, it is desirable to provide an improved method of channel tagging in optical communication systems. The improved method of channel tagging should achieve signal propagation with minimal attenuation through the entire optical network and yet not contribute to the optical penalty associated with the channel.

### SUMMARY OF THE INVENTION

In accordance with the present invention, an improved method is provided for channel tagging optical data signals in an optical communication system. The method includes: generating an optical carrier having a given wavelength from an optical signal source; modulating the frequency of the optical carrier at the optical signal source, thereby embedding a tag in the optical carrier; modulating the tagged optical carrier with a data signal to form an optical data signal; and transmitting the optical data signal in the optical communication system.

For a more complete understanding of the invention, its objects and advantages, reference may be had to the following specification and to the accompanying drawings.

### BRIEF DESCRIPTION OF THE DRAWINGS

FIG. 1 is a flowchart illustrating an improved method of channel tagging optical data signals in an optical communication system in accordance with the present invention;

FIG. 2 is a block diagram of an exemplary FM modulator integrated with an optical signal source in accordance with the present invention; and

FIG. 3 is a diagram illustrating the relationship between an incoming optical signal spectrum and the transfer characteristic of the optical filter in accordance with the present invention.

### DETAILED DESCRIPTION OF THE PREFERRED EMBODIMENTS

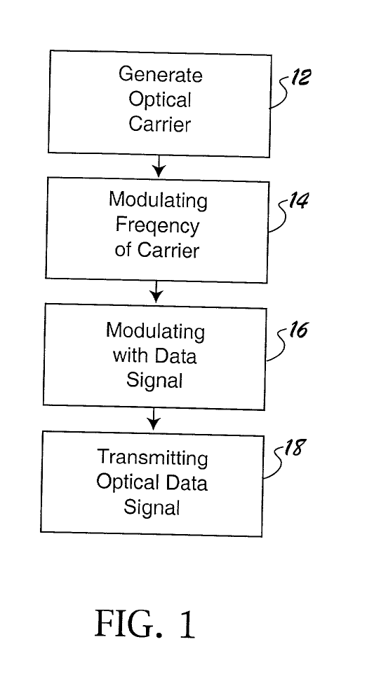

An improved method for channel tagging 10 optical data signals in an optical communication system is shown in FIG. 1. An optical carrier having a given wavelength may be generated 12 using an optical continuous wave signal source. A channel tag is embedded in the optical carrier by modulating the frequency (i.e., the wavelength) of the optical signal source as shown at step 14. A high speed data signal is also embedded into the optical carrier 16 to form an optical data signal. The optical data signal, including the channel tag and data, is then transmitted 18 in the optical communication system. In this way, a channel tag may be embedded, without optical penalty, into an optical data signal which will propagate with minimal attenuation through the entire optical network.

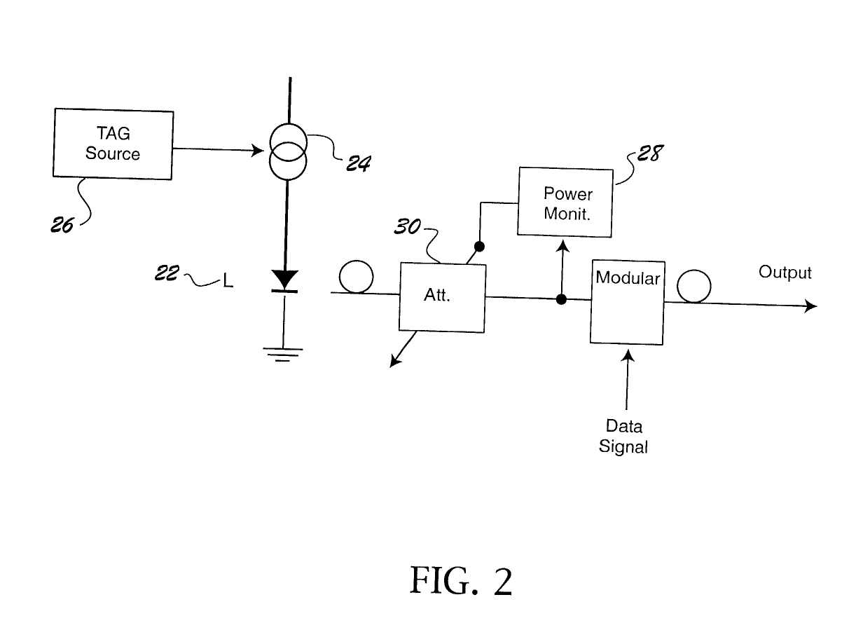

FIG. 2 illustrates how a conventional continuous wave optical signal source may be integrated with an FM modulator in an optical communication system. A current source 24 is used to drive the laser diode 22 as is well known in the art. The wavelength of the optical signal source will depend on the type of signal source as well as the operating conditions (e.g., current or temperature) of the signal source. It is envisioned that other types of optical signal sources are also within the scope of the present invention. For instance, a direct laser modulation technique may also be used to generate the optical signal source. In this case, a laser diode operating at a high data rate (e.g., in the order of 1-10 GHz) is used to generate an optical data signal.

In the preferred embodiment, the wavelength (i.e., frequency) of the optical signal source is modulated by periodically changing the operating current of the laser diode 22. A tagging source 26 is provided to control the operation of the current source 24, thereby applying the applicable channel tag to the optical signal source. The optical signal source is preferably modulated with frequency deviation and tag signal data rate such that overall width of the spectrum of the optical channel is not affected. For instance, 1 mA change in the biasing current provided to the laser diode will result in an approximate 1 GHz frequency change in the optical carrier. As a result, the optical carrier is embedded with a tag or sub-carrier signal which may be used to carry network management data. In the context of a DWDM optical system, the tag may be preferably used to indicate an unique identifier for the source of the optical data signal.

One skilled in the art will readily recognize for such discussions that the output power may vary slightly in an FM modulated optical signal. It is envisioned that this residual amplitude modulation of the optical signal can be cancelled via some additional feedback control or forward compensation circuitry. An exemplary feedback control circuit is depicted in FIG. 2. A power monitor 28 is used to monitor a portion of the outgoing optical data signal. The output power of the optical signal is stabilized using an attentuator 30 which is electrically coupled to the power monitor 28. In particular, the output power of the optical signal is adjusted by the attentuator 30 based on the input received from the power monitor 28.

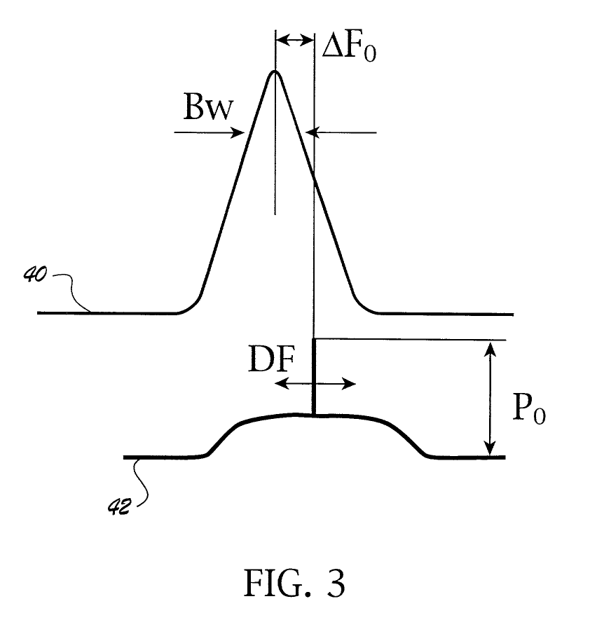

The channel tag embedded in the optical data signal is subsequently extracted using a FM demodulator. As one of the practical implementations, the optical data signal may be passing through a narrow bandpass optical filter. The center frequency of the filter should be offset in respect to the center frequency of the monitored signal. The typical frequency offset for such a demodulator is that the center frequency of the monitored signal be positioned on the slope of the filter, somewhere between −3 dB and −20 dB filter attenuation points. As will be apparent to one skilled in the art, changes in the average signal power after the filter correlate to frequency deviation (changes in the wavelength) of the optical data signal as introduced by the FM modulator. The relationship between the incoming optical signal spectrum 42 and the transfer characteristic of the optical filter 40 is illustrated in FIG. 3. Thus, the embedded channel tag can be ascertained by monitoring the average signal power of the filtered optical signal.

In a first preferred embodiment, an optical spectrum analyzer (OSA) having a tunable optical filter may be used to demodulate the optical signal. In this approach, the tunable optical filter reads one channel at any given time. In another preferred embodiment, the incoming optical data signal is diffracted and applied to a detector array as found in a CCD-based optical spectrum analyzer. In other words, the equivalent of a plurality of fixed optical filters are used to receive the optical data signal. To the extent the optical signal is carrying multiple channels, the channel tag for each different channel may be processed in parallel. It is envisioned that other well known demodulators may also be used within the scope of the present invention.

While the invention has been described in its presently preferred form, it will be understood that the invention is capable of modification without departing from the spirit of the invention as set forth in the appended claims.

What is claimed is:

1. A method for channel tagging optical data signals in an optical communication system, comprising;
generating an optical carrier having a given wavelength from an optical signal source;
modulating the frequency of the optical carrier at the optical signal source, thereby embedding a tag in the optical carrier;
modulating the tagged optical carrier with a data signal to form an optical data signal; and
transmitting the optical data signal in the optical communication system.

2. The method of claim 1 wherein the tag embedded in the optical data signal is indicative of a signal characteristic associated with the optical data signal.

3. The method of claim 1 wherein the step of generating an optical carrier further comprises using a laser diode and the step of tagging the optical data signal further comprises changing an operating current of the laser diode, thereby modulating the frequency of the optical carrier.

4. The method of claim 1 wherein the step of modulating the frequency and the step of modulating the tagged optical carrier are combined using a direct laser modulation technique.

5. The method of claim 1 further comprises the step of demodulating the optical data signal to determine the tag embedded in the optical data signal.

6. The method of claim 5 wherein the step of demodulating the optical data signal further comprises receiving the optical data signal at an optical filter, detuning the optical filter, and monitoring an average signal power of a filtered optical signal from the optical filter, where changes in the average signal power of the filtered optical signal correlate to changes in the wavelength of the optical data signal.

7. The method of claim 5 wherein the step of demodulating the optical data signal further comprises using an optical spectrum analyzer having a tunable optical filter.

8. The method of claim 5 wherein the step of demodulating the optical data signal further comprises the steps of diffracting the optical data signal into a plurality of optical signal components and receiving said plurality of optical signal components by a CCD-based optical spectrum analyzer.

9. A method for demodulating an optical data signal in an optical communication system, the optical data signal having a channel tag embedded therein, comprising:
receiving the optical data signal at an optical filter;
detuning the optical filter from the wavelength of the optical data signal; and
monitoring an average signal power of the filtered optical signal, thereby determining the channel tag embedded in the optical data signal.

10. The method of claim 9 wherein the channel tag embedded in the optical data signal is indicative of a signal characteristic associated with the optical data signal.

11. The method of claim 9 wherein the channel tag is embedded in the optical data signal by modulating the frequency of the optical data signal and changes in the average signal power of the filtered optical signal correlate to changes in the wavelength of the optical data signal.

12. The method of claim 9 wherein the step of receiving the optical data signal further comprises using an optical spectrum analyzer having a tunable optical filter.

13. The method of claim 9 wherein the step of receiving the optical data signal further comprises using a CCD-based optical spectrum analyzer.
